(19) United States
(12) Patent Application Publication
(10) Pub. No.: US 2009/0108012 A1
(43) Pub. Date: Apr. 30, 2009

(54) Method for a coin-operated microwave oven

(76) Inventor: Jackie T. Price, Atlanta, GA (US)

Correspondence Address: Harry I. Leon, 924 Bowen St. NW, Atlanta, GA, 30318, US

(21) Appl. No.: 11/978,300

(22) Filed: Oct. 29, 2007

(51) Int. Cl. G07F 5/00; G07F 11/00

(52) U.S. Cl. 221/1

(57) ABSTRACT

A method of making a microwave oven coin operative which includes cutting, just inside the shell of the oven, the input hot power line and connecting its two cut ends to the normally open contacts of a relay. A low voltage control circuit which comprises the secondary side of a step down transformer, a coin acceptor, a timer and a relay control coil is used to close the contacts. So that power can be provided upon demand to the control circuit, the primary coil of the transformer is kept always operative. Input thereto is supplied by the hot wire and the neutral wire. When fed coin(s) of the proper denomination, the coin acceptor energizes a timer circuit; and it in turn, sends power to the relay control coil, thereby closing the contacts and powering the microwave oven for the time interval up to that preset on the timer.

### BACKGROUND OF THE INVENTION

Many offices, factories, hotels and schools are equipped with coin-operated food dispensers. Persons who bring their own meals or use the food dispensers often want to warm the food first before they consume it. A microwave oven is the instrument of choice for warming these meals. Many times, however, facility managers hesitate to provide this amenity because of the cost associated with accruing, maintaining and operating it.

### SUMMARY OF THE INVENTION

The object of the present invention is to provide a novel, low cost method of making , a microwave oven coin operative, so that one can receive compensation for the use of the microwave oven. Thereby, allowing the managers or owners a means to make it economically feasible to place such a microwave oven near wherever food is either dispensed or consumed or both.

In accordance with the present invention, there is provided such a method which comprises supplying electrical power on demand to a control circuit which includes the secondary coil of a transformer, a coin acceptor, a timer, and a control coil for a relay. The relay coil closes the normally opened contacts on the timer. When the contacts are closed by the relay coil, power is delivered to the microwave for the preset time on the timer.

Preferably, the coin acceptor, after being fed coin(s) of the proper denomination or, alternately, receiving a suitable amount of compensation by way of a credit card, initiates a two-step process in which a timer circuit is activated and then sends power to the relay control coil for a preset time interval.

A preferred combination with which such a method of making a microwave oven coin operative can be practiced is one in which the transformer, the coin acceptor, the timer, and the relay and control coil, as well as the microwave oven, are all housed in a common enclosure shell which is usually larger than that which would be required for the microwave oven by itself.

Alternately, the coin acceptor and the timer controls could be housed in an attached housing as disclosed by the applicant in U.S. Pat. No. D541579.

### BRIEF DESCRIPTION OF THE DRAWINGS

FIG. 1 is a front right side perspective view of the coin-operated microwave manufactured according to the present invention;

FIG. 2 is a top plan of the coin-operative microwave oven according to FIG. 1;

FIG. 3, 4, 5 and 7 are is right side, front, back and left side elevational views, respectively, of the coin-operative microwave oven according to FIG. 1;

FIG. 6 is a back, right side perspective view of the coin-operative microwave oven according to FIG. 1;

FIG. 8 is a bottom plan of the coin-operative microwave oven according to FIG. 1;

FIG. 9 is a schematic wiring diagram of the coin-operative microwave oven according to FIG. 1.

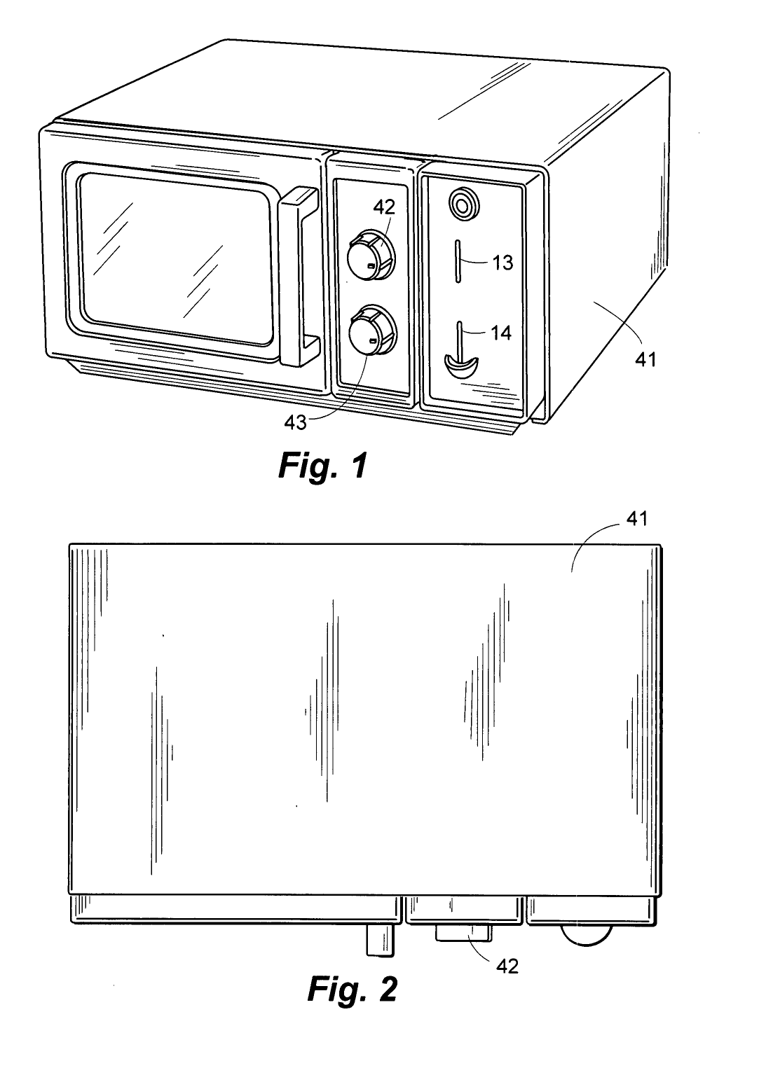

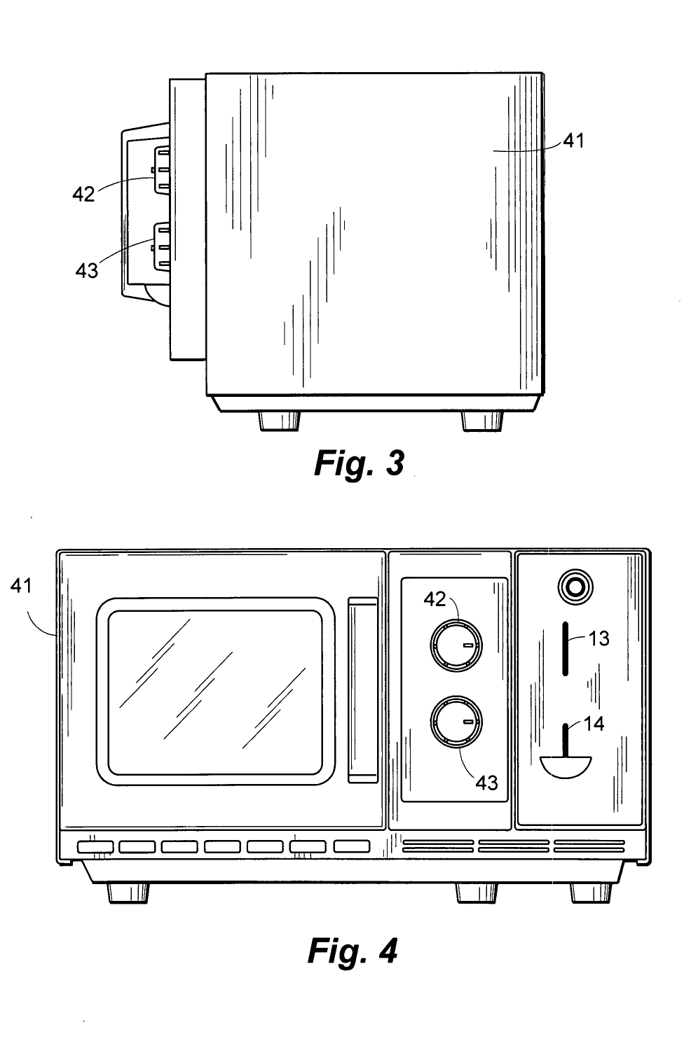

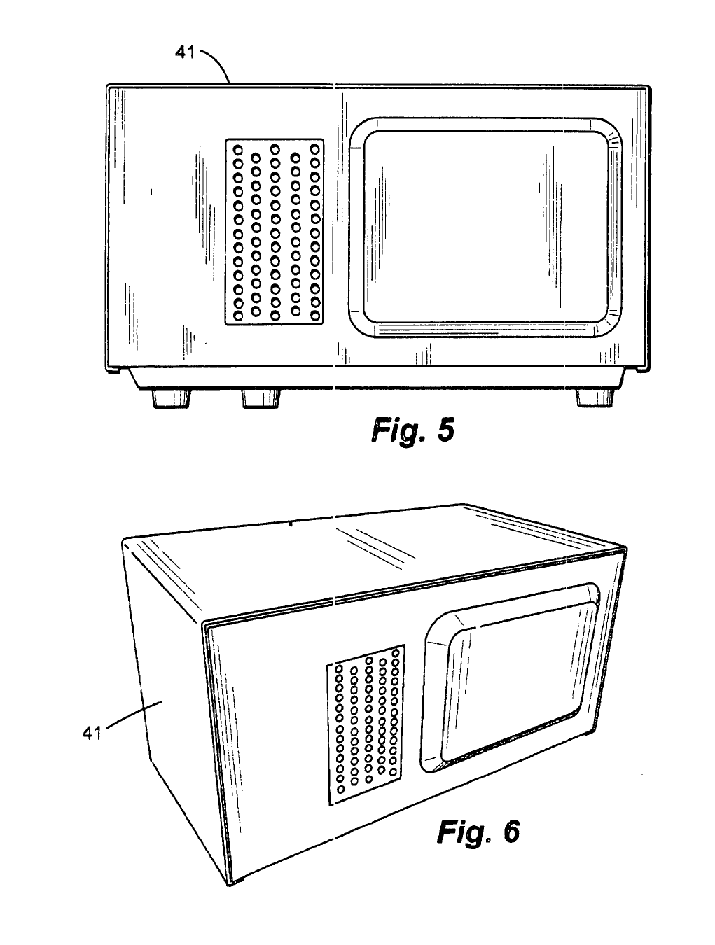

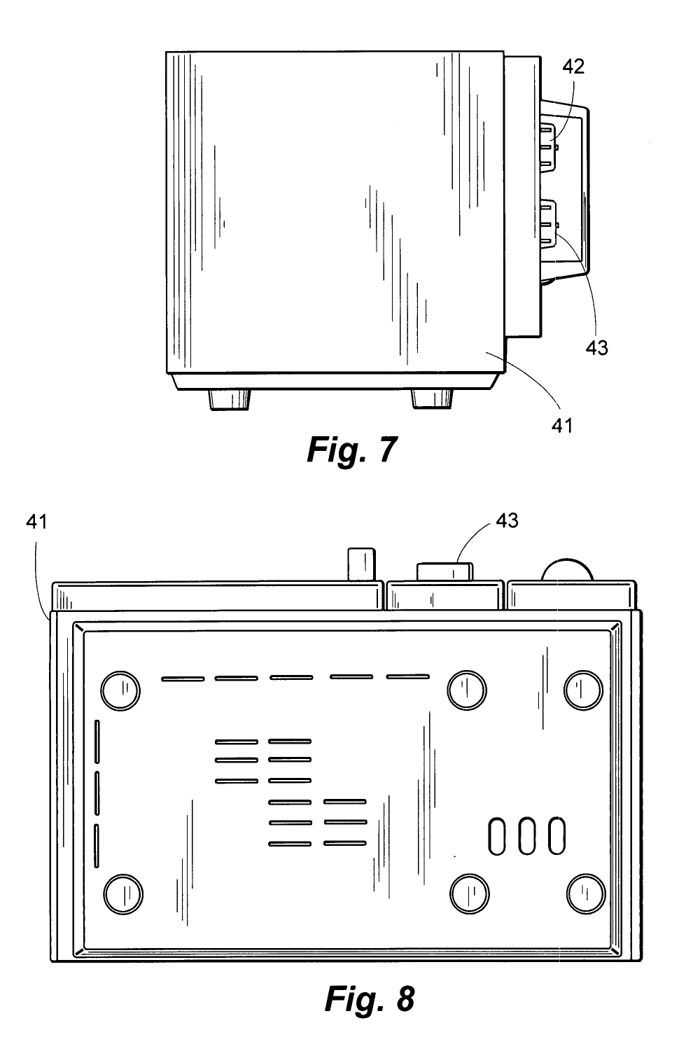

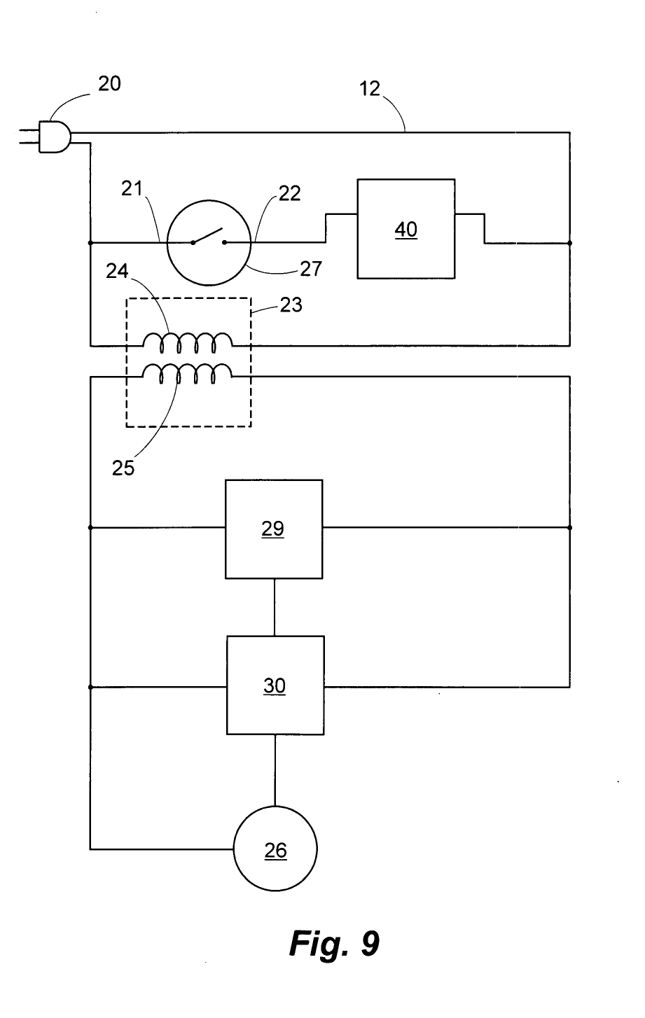

### DESCRIPTION OF THE PREFERRED EMBODIMENT

In accordance with the present invention, the first step in making a microwave oven 40 coin-operative is to cut the hot side of a power cord 20 immediately after it enters the shell 41 enclosing the microwave oven, while simultaneously leaving the neutral side 12 of the power cord intact. Next, one connects the hot and cold sides 21, 22 of cut power cord to normally open contact terminal in a relay 27. Only by activating relay coil 26, can one then close the contacts in the relay 27 and restore power to the microwave oven 40.

Control of the relay coil 26 is achieved with the use of a two step process involving a coin acceptor 29 and a timer 30. To supply power to the coin acceptor 29, one must first connect the primary side 24 of a step-down transformer 23 to the hot side: 21 of the power cord and to the neutral wire 12 so that the primary side is always powered. The secondary side 25 of the transformer 23 is then connected to the coin acceptor 29. A suitable transformer having 115 ac primary and 24 volt ac secondary is supplied by TriCad model FD8-24. When coin(s) of the proper denominations are subsequently inserted into the coin acceptor 29, it sends power to the timer 30 which, in turn, activates the relay coil 26 closing the contact terminals in the relay 27 and allowing the microwave oven 40 to operate for a set time interval. The length of the set time interval is preferably determined by preprogramming the timer 30. Moreover, in the preferred embodiment, the coin acceptor 29 is programmed to accept coins of one particular denomination such as quarters ($0.25).

Suitable coin acceptors 29 and timers 30 which can be used in combination in the two step process for controlling the relay coil 26 are, respectively, the model Ep5 available commercially from SecureCoin and the Model No. PEM-7 supplied by Parker Engineering. In this combination, the coin acceptor 29 can be programmed to be activated from 1 to 4 coins; and the timer 30 can be programmed to be activated for set time intervals which range in length from less than 1 second to many minutes, For example of a setting which can be easily programmed into the this coin acceptor-timer combination is one in which when the coin acceptor 29 receives a quarter ($0.25), the timer is then activated for 5 minutes.

In preparation for using the coin-operated microwave oven, a consumer would place his food inside it and then set dials 42, 43 according to the length of time and power level at which he wishes to heat the food. He would then insert the proper coins into slot 13 in the coin acceptor 29 in order to activate the microwave oven. In some situations, the user may need to insert additional coins in the coin slot 13 in the event his food needs further heating beyond the set time interval for which the timer 30 was programmed to be activated.

A coin return slot 14 is also provided in case a coin of the wrong denomination is inserted into the coin slot 13 or a power failure occurs.

In alternate embodiments, the coin acceptor 29 is replaced with a credit card r. Also, the control circuit for the relay can be operated at full input voltage. In view these and many other variations which can be incorporated into a method of making a microwave oven coin-operative, it is to be understood that this description is made only be example, and not as a limitation on the scope of the invention.

It is claimed:

1. A method for receiving compensation for the use of a microwave oven, which comprises:
(a) continuously supplying electrical power to the primary coil of a transformer;
(b) providing electrical power upon demand to a control circuit which included the secondary coil of the transformer, a coin acceptor, a timer, and a control relay with normally open contacts; and
(c) closing of the normally open contacts of the relay, the relay contacts being connected to the two cut ends of an input hot power line which would otherwise feed electrical power directly into the microwave oven, the input hot power line is connected to the primary coil of the transformer, the timer comprising means for presetting the time interval during which the normally open contacts of the relay remain closed after the coin acceptor receives compensation and activates the timer.

2. A method of converting a microwave oven to operate as a coin operating apparatus comprising:
(a) a coin acceptor that will receive the proper compensation for the use of the microwave oven;
(b) a timer circuit that is activated by the coin acceptor when compensation is received; and
(c) a relay that is activated by the timer circuit that has contacts that will connect power to the microwave oven for the preset time on the timer.
